(19) United States
(12) Patent Application Publication
(10) Pub. No.: US 2016/0292641 A1
(43) Pub. Date: Oct. 6, 2016

(54) ORGANIZATIONAL INTEREST MODELING

(71) Applicant: Linkedln Corporation, Mountian View, CA (US)

(72) Inventors: Kun Liu, Sunnyvale, CA (US); Wen Pu, Mountain View, CA (US); Anmol Bhasin, Los Altos, CA (US); Huiji Gao, San Jose, CA (US); Haishan Liu, Sunnyvale, CA (US)

(21) Appl. No.: 14/675,729

(22) Filed: Mar. 31, 2015

(51) Int. Cl. G06Q 10/10; G06Q 50/00

(52) U.S. Cl. CPC G06Q 10/1053; G06Q 50/01

(57) ABSTRACT

Techniques for assisting a user in determining an interest level between a member of a social network system and an organization. According to various embodiments, applicant data is accessed for applicants having applied to an organization. A set of common applicant characteristics is determined for the set of applicant data. Member data is accessed indicative of a member of an online social media network. An interest score is generated based on a comparison of the member data and the set of applicant data. An identification of the organization is presented based on the interest score.

### TECHNICAL FIELD

The present application relates generally to data processing systems and, in one specific example, to techniques for presenting a user with organizational information based on a determined affinity between a user and an organization.

### BACKGROUND

Online social network services such as LinkedIn® are becoming increasingly popular, with many such websites boasting millions of active members. Each member of the online social network service is able to upload an editable member profile page to the online social network service. Further, online social network services such as LinkedIn® include a search feature where, for example, a member may search for other member profile pages, company profile pages, jobs, etc., posted on the online social network service.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example organizational interest system, according to various embodiments;

FIG. 3 is a flowchart illustrating an example method, according to various embodiments;

FIG. 4 is a flowchart illustrating an example method, according to various embodiments;

FIG. 5 is a flowchart illustrating an example method, according to various embodiments;

FIG. 6 illustrates an example mobile device, according to various embodiments; and

FIG. 7 is a diagrammatic representation of a machine in the example form of a computer system within which a set of instructions, for causing the machine to perform any one or more of the methodologies discussed herein, may be executed.

### DETAILED DESCRIPTION

Example methods and systems for presenting a user with organizational information based on a determined affinity between a user and an organization (e.g., company) are described. In the following description, for purposes of explanation, numerous specific details are set forth in order to provide a thorough understanding of example embodiments. It will be evident, however, to one skilled in the art that the embodiments of the present disclosure may be practiced without these specific details.

Social networking services provide various profile options and services. In some instances a social network may connect members (e.g., individuals associated with the social network) and organizations alike. Social networking services have also become a popular method of performing organizational research and job searching. Job listings representing openings (e.g., employment and volunteer positions) within an organization may be posted and administered by the organization or third parties (e.g., recruiters, employment agencies, etc.).

Where the organization or third party is actively seeking out and contacting potential candidates for a position represented by a job listing, determining an interest of a member for the position and the organization can be difficult. Further, determining whether a member is likely to apply for the position can present additional difficulties. Where the organization or third party receives large volumes of applications or resumes from candidates (e.g., members of the social network) in response to the job listing, the organization or third party may encounter difficulties processing between candidates who are qualified and display a possible interest for the organization and those which do not. Similarly, where a member of the social network receives a large number of job listings as a result of a query of the social networking service, it can be difficult for the member to discern an interest level for each organization and whether to apply for a position if that member is not specifically searching for a predetermined organization or position. Therefore, a better social network service would selectively generate and relay filtered search results (e.g., job listings, an identification of an organization, candidate members, etc.) representative of an interest level and a likeliness of the member to take action (e.g., apply for a position linked to a job listing) on the search results.

An organizational interest system, serving as a portion of a social networking service or as a stand-alone social networking service, can determine an interest level of a member for an organization or a specific job listing or position within the organization. Further, based on prior applicants and information gleaned for the member, the organizational interest system serves to determine a likelihood that the member will apply for any given position within a set of positions returned within a results list based on a search by the member or a third party. The organizational interest system can then provide results based on the one or more interest scores. In some embodiments, the organizational interest system can generate the one or more interest scores based on organizational data (e.g., organization profile data of the social network), member data (e.g., member profile data of the social network), and applicant data (e.g., member profiles of members who have previously applied to the organization). The processes and methods of the organizational interest system and the data used therein will be described in further detail below.

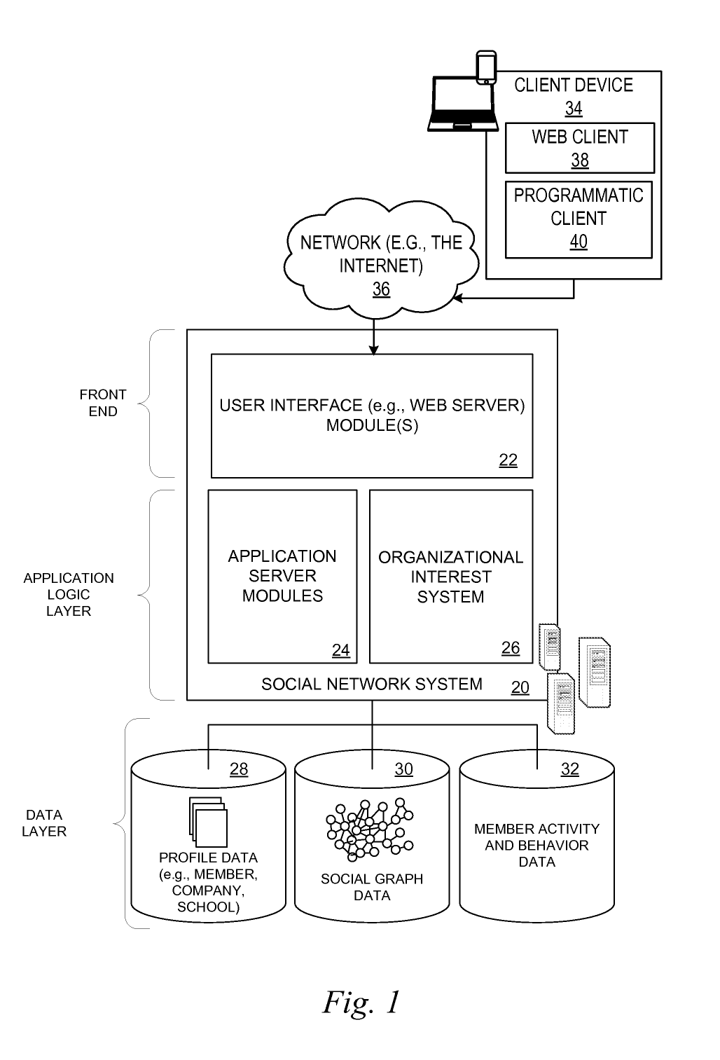

FIG. 1 is a block diagram illustrating various components or functional modules of a social network service such as the social network system 20, consistent with some embodiments. The social network system 20 may provide a portion or the entirety of an online social media network through which individuals (e.g., members of the social network system 20 and the online social media network) may connect to one another, to organizations, and the like. As shown in FIG. 1, the social network system includes a front end, an application logic layer, and a data layer. The front end includes a user interface module 22. The application logic layer includes an application server module 24 and an organizational interest system 26. The data layer contains at least one database 28. As shown, the at least one database 28 includes profile data, social graph data, and member activity and behavior data. Further, as shown the at least one database 28 may be a plurality of databases 28-32, with each database of the plurality of databases 28-32 containing a set of data including all or a portion of the profile data, the social graph data, and the member activity and behavior data. It will be understood that although shown as the plurality of databases 28-32, the data stored across the plurality of databases 28-32 can be stored on a single database 28.

The front end, consisting of the user interface module 22 (e.g., a web server) receives requests from various client-computing devices 34, and communicates appropriate responses to the requesting client devices 34. The user interface module 22 can communicate with the client devices 34 via a network 36. For example, the user interface module 22 may receive requests in the form of Hypertext Transport Protocol (HTTP), or other web-based, application programming interface (API) requests.

The application logic layer includes various application server modules 24, which, in conjunction with the user interface module(s) 22, generate various user interfaces (e.g., web pages) with data retrieved from various data sources in the data layer. In some instances, individual application server modules 24 are used to implement the functionality associated with various services and features of the social network service. For instance, services may include the ability of an organization (e.g., for-profit company, non-profit company, non-governmental organization, governmental entity, etc.) to establish a presence in the social graph of the social network service, including the ability to establish a customized web page on behalf of an organization, and to publish messages or status updates on behalf of an organization. These services may be implemented in independent application server modules 24 or in a single application server module 24. Similarly, a variety of other applications or services that are made available to members of the social network service can be embodied in their own application server modules 24.

The data layer includes the plurality of databases 28-32, such as a database 28 for storing profile data, including both member profile data as well as profile data for various organizations (e.g., company profile data and employee profile data). The database 30 stores various associations and relationships that members establish with other members or organizations (e.g., companies), or with other entities and objects. These associations and relationships are stored within a set of social graphs within the database 30. The database 32 stores member and organization interactions, activities, and behaviors within the social network.

With respect to the profile data stored in the database 28, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. Similarly, when a representative of an organization initially registers the organization with the social network service, the representative may be prompted to provide certain information about the organization. This information may be stored, for example, in the database 28, or another database (not shown).

In some embodiments, the profile data may be processed (e.g., in the background or offline) to generate various derived profile data. For example, if a first member has provided information about various job titles the member has held with the same organization or different organizations, and for how long, this information can be used to infer or derive a first member profile attribute indicating the first member's overall seniority level, or seniority level within a particular organization. Further, the derived profile data, indicative of an association with an organization or a second member (e.g., employment relationship or co-worker relationship), can be linked, included, or otherwise associated with the organization profile or the second member profile to represent the association (e.g., employment relationship or co-worker relationship) between the first member and the organization or second member. Additionally, in some instances, importing or otherwise accessing data from one or more externally hosted data sources may enhance profile data for both members and organizations. For instance, with companies in particular, financial data may be imported from one or more external data sources, and made part of an organization's profile. Once registered, a member may invite other members, or be invited by other members, to connect via the social network service.

Referring to the social graph data stored in the database 30, a “connection” may require a bi-lateral agreement by two members, such that both members acknowledge the establishment of the connection. Similarly, in some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream.

In any case, the various associations and relationships that the members establish with other members, or with other entities and objects, are stored and maintained within the social graph data, shown in FIG. 1 as stored in the database 30. The associations and relationships can include employment relationships (e.g., employer/employee relationships or co-worker relationships), professional associations (e.g., members in a common professional organization), social associations, scholastic associations (e.g., matriculation or graduation from a common school or educational institution), and other suitable associations.

In addition to connections and following, the social network service may provide a broad range of other applications and services that allow members the opportunity to share and receive information, often customized to the interests of the member. For example, with some embodiments, the social network service may include a photo sharing application that allows members to upload and share photos with other members. In some embodiments, members may be able to self-organize into groups, or interest groups, organized around a subject matter or topic of interest.

Further, in some instances, the social network service may host various job listings providing details of job openings with various organizations. The social network service can include paid job listings (where users have paid to post such jobs on the social network service), as well as unpaid job listings which may be ingested from third party websites. Such third party websites often post large numbers of similar or identical jobs having similar or identical employers, locations, job functions, position characteristics, etc. Previously, the paid job postings tend to be highly relevant to a certain job searchers, and the suggested facet-value pairs were tailored to that quality set of results. However, with the inflow of unpaid job listings, the same suggestions may be less relevant and, in some cases, lead to bad experiences. For example, the popularity metric (described above) for measuring a raw number of clicks may be skewed based on the ingestion of a large quantity of similar or identical job listings. As will be described below, the organizational interest system 26 can generate interest metrics (e.g., an interest score indicating one or more of a quantification of an interest of a member for an organization or position and a likelihood that the member will apply for a given position within an organization) and provide data identifying companies or organizations which are determined to be of interest to a member searching for a job or a member for whom a job is being searched.

As members interact with the various applications, services, and content made available via the social network service, the members' behavior (e.g., content viewed, links or member-interest buttons selected, etc.) are monitored and information concerning a member's activities and behavior may be stored, for example, in the database 32, as shown in FIG. 1.

The client device 34 contains a web client 38 which may access the social network service and the various applications, services, and content made available via the social network service, including at least some aspects of the organizational interest system 26, via a web interface supported by the user interface module 22 or the application server module 24. In some embodiments, the client device 34 can contain a programmatic client 40 configured to access certain of the various applications, services, and content made available via the social network service without use of the network 36 and/or the web client 38.

The network 36 may be any network that enables communication between or among machines (e.g., the social network system 20), databases (e.g., the databases 28-32), and devices (e.g., the client device 34). Accordingly, the network 36 can be a wired network, a wireless network (e.g., a mobile or cellular network), or any suitable combination thereof. The network 36 can include one or more portions that constitute a private network, a public network (e.g., the Internet), or any suitable combination thereof. Accordingly, the network 36 can include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 36 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

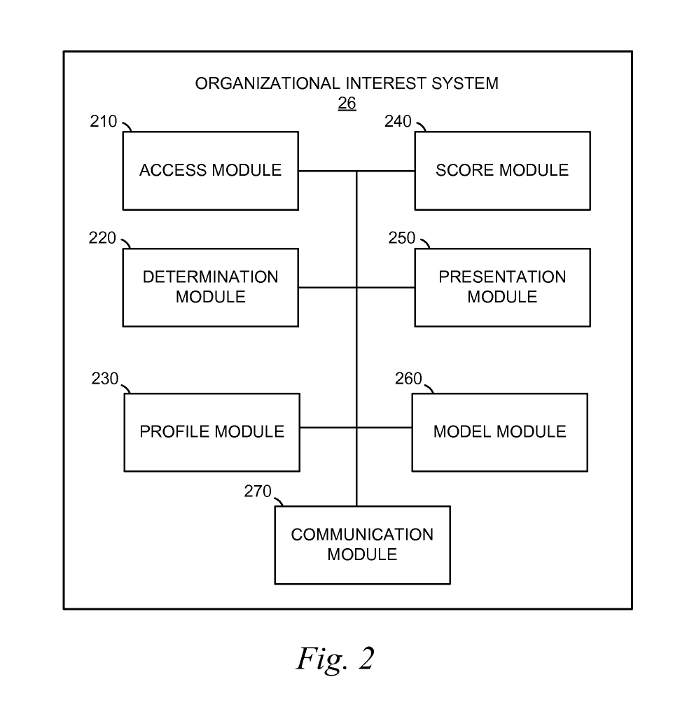

FIG. 2 is a block diagram illustrating components of the organizational interest system 26. The organizational interest system 26 is shown including an access module 210, a determination module 220, a profile module 230, a score module 240, a presentation module 250, a model module 260, and a communication module 270, all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The access module 210 is a module within the organizational interest system 26 capable of accessing and receiving profile data, use data indicative of actions taken by one or more users of the social network system 20 while engaging with or performing actions in communication with the social network system 20. The access module 210 accesses member data, applicant data, and organization data. For example, the access module 210 can access member data, applicant data, and organization data on any one of the databases 28-32, or across multiple databases in order to access profile data, social graph data, and activity and behavioral data for a set of members, a set of applicants, and a set of organizations. In some instances, the access module 210 is configured to access the member data, applicant data, and the organization data of the organization via the communication module 270 communicating requests, responses, and other communication data indicative of accessing the databases 28-32. In some embodiments, the access module 210 can receive member data, applicant data, or organizational data from one or more sources such as the client device 34 of a member of the social network system 20.

The determination module 220 determines a set of common applicant characteristics (e.g., one or more common aspect, qualification, or characteristic) from the applicant data accessed by the access module 210. The set of common applicant characteristics can be understood as a set of characteristics shared among the set of applicants having applied to an organization. The set of characteristics can be understood as a portion of data representing a feature or quality of a member of the social network system 20. The portion of data indicative of each characteristic of the set of characteristics is stored within the member profile. In some instances, the aggregate of the set of characteristics can be understood to make up the defining aspects of the member including skills educational history, school rankings, length of employment, certifications, awards, endorsements, publications patents, previous employment positions and durations, and other features, qualities, or aspects of the member.

In some embodiments, the determination module 220 can determine a plurality of sets of common applicant characteristics. For example, the set of applicant data can include data from a first set of applicants applying to a first position and a second set of applicants applying to a second position. Where the first position and the second position are disparate in functions, roles, responsibilities, and requirements, the first set of applicants and the second set of applicants may share common applicant characteristics within a given set. However, the first set of applicants may share a set of first applicant characteristics disparate from a set of second applicant characteristics shared by the second set of applicants. In embodiments such as these, the determination module 220 determines a plurality of sets of common applicant characteristics among a plurality of sets of applicants, with each set of applicants sharing a set of common applicant characteristics.

The profile module 230 generates an applicant profile for the organization. The applicant profile includes the set of common applicant characteristics. In some embodiments, the applicant profile is similar to a member profile of the social network system 20. In some embodiments, the applicant profile is a collection of data representative of common aspects of the set of applicants. The applicant profile can be stored in the database 28 as a table of associated values indicative of the common applicant characteristics. The applicant profile can be made available for access and use by one or more modules of the organization interest system 26.

The scoring module 240 generates an interest score for the member based on comparison of the member data and the applicant profile. The scoring module 240 can generate the interest score by comparing keywords among the member data and the applicant profile, comparing values for values represented at least in part by numbers (e.g., integers), comparing categories associated with one or more member characteristic of the member data and one or more of the applicant characteristics of the applicant profile. In some embodiments, the scoring module generates a single interest score for the member based on a determined similarity across all of the member data and applicant profile data. In some instances, the scoring module 240 generates a set of interest scores (e.g., a plurality of interest scores). Where the scoring module 240 generates a set of interest scores, the set of interest scores may form the basis of the single interest score discussed above. In some instances, the set of interest scores can indicate varying degrees of similarity among the member data and a set of applicant profiles.

The presentation module 250 causes presentation of an identification of an organization to the member based on the interest score. In some embodiments, the presentation module 250 causes presentation of the identification of the organization based on an interest model. The presentation module 250 can cause presentation of the identification by transmitting the identification of the organization to the client device 34. The presentation module 250 can generate one or more graphical user interface elements, screens, web pages, or the like, presenting the identification of the organization on the user interface of the client device 34. In some embodiments, the presentation module 250 causes presentation of the identification of the organization by transmitting data indicative of the identification to the client device 34, such as via the Internet, a wireless network, or any other suitable communications network in conjunction with the communication module 270. In some instances, a portion of the presentation module 250 is implemented by the client device 34 (e.g., a portion of an application running on the client device 34) to cause presentation of the identification of the organization on the user interface. The presentation module 250 can be a hardware implemented module which configures the organizational interest system 26 or the client device 34 to perform the functions described above and below.

The model module 260 generates an interest model for the member. The interest model is based on the interest score and the member data. The interest model may be understood as a quantitative representation of a level of interest of a member in a particular organization. In some embodiments, the interest model is based on the interest score and a comparison of one or more preferred organization characteristics of the member and one or more organization characteristics of the organization. In some instances, the interest model may be based on the interest score and a set of connection indicators. The set of connection indicators representing a set of associations between the member and a set of members of the social network system 20.

The communication module 270 enables communication between the client device 34, the organizational interest system 26, the user interface 22, the application server modules 24, and the database 28. In some example embodiments, the communication module 270 enables communication among the access module 210, the determination module 220, the profile module 230, the score module 240, the presentation module 250, and the model module 260. The communication module 270 can be a hardware module and can incorporate software or processor executable instructions, explained in more detail below. In some instances, the communications module 270 includes communications mechanisms such as an antenna, a transmitter, one or more busses, and other suitable communication mechanisms capable of enabling communication between the modules 210-270, the client device 34, the user interface 22, the application server modules 24, and the database 28.

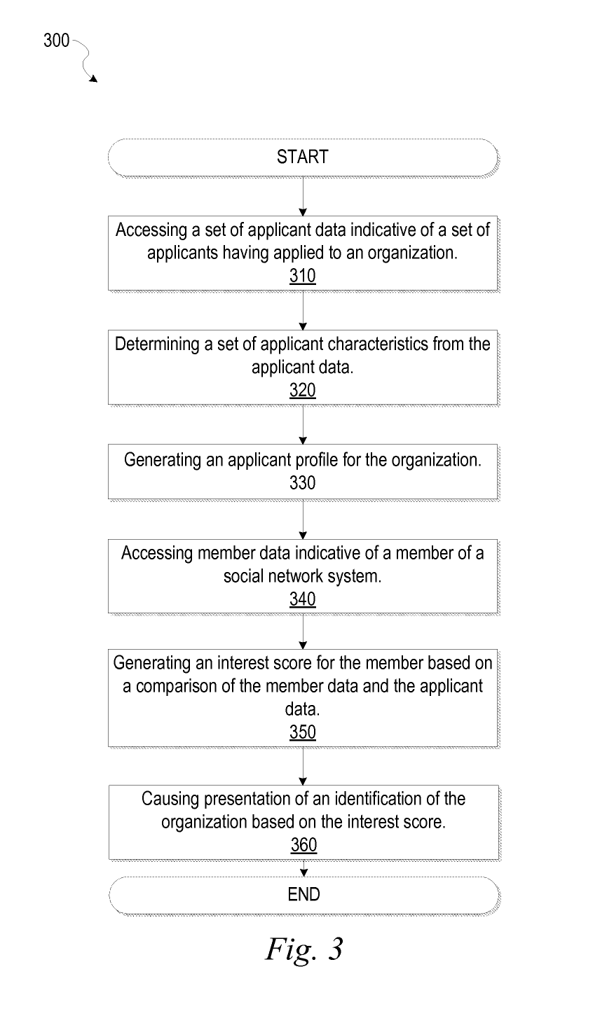

FIG. 3 is a flowchart illustrating an example method 300, consistent with various embodiments described herein. The method 300 may be performed at least in part by, for example, the organization interest system 26 illustrated in FIG. 2 (or an apparatus having similar modules, such as one or more client machines or application servers).

In operation 310, the access module 210 accesses a set of applicant data indicative of a set of applications having applied to an organization. The set of applicant data may include one or more applicant characteristics. The access module 210 may access the set of applicant data using the communication module 270 to transmit requests and responses between the access module 210 and one or more of the plurality of databases 28-32. In some embodiments, in order to access the set of applicant data, the access module 210 or another module (e.g., the determination module 220) identifies one or more members of the social network system 20 having member data (e.g., data within the member's profile) which indicates that the member applied for a position with the organization. The access module 210 or another module may then determine the one or more members to be included within the set of applicants.

In some additional embodiments, where the access module 210 may cooperate with one or more other modules to determine one or more employee member of the social network system 20 currently employed by the organization. The access module 210 may access the member data for the one or more employee member and determine a set of historical member data indicative of each of the one or more employee members for the time at which the one or more employee members applied to the organization. The set of historical member data can be returned as the set of applicant data for the one or more employee members included in the set of applicants.

In operation 320, the determination module 220 determines a set of applicant characteristics from the applicant data. For example, the determination module 220 can perform a keyword search on the set of applicant data to determine one or more keywords occurring in the applicant data of one or more applicants of the set of applicants. In some embodiments, the determination module 220 compares one or more numerical values (e.g., years of employment and duration of employment) stored within the set of applicant data and further includes the numerical values within the common applicant characteristics. The numerical values can be associated with one or more applicant characteristics to which the numerical value is related (e.g., duration of employment as a software engineer) in a separate field or characteristic. In some embodiments, the numerical value can be integrated into a quantification of the applicant characteristic with which it is associated such that the resulting quantity is representative of both the applicant characteristic and the numerical value.

In some embodiments, operation 330 may be performed as a sub-operation of operation 320. In operation 330, the profile module 230 generates an applicant profile for the organization. The applicant profile includes at least a portion of the set of applicant characteristics. For example, the determination module 220 can determine a set of common applicant characteristics as a subset of the set of applicant characteristics. The common applicant characteristics can be understood to be a set of features, skills, qualities, experiences, education, or identifying aspects common to all or a portion of the set of applicants. In some embodiments, the applicant profile can contain the set of common applicant characteristics without including characteristics from the set of applicant characteristics which are not determined to be shared among the applicants. In some instances, the applicant profile can include all of the set of applicant characteristics. Further, where the applicant profile includes all of the set of applicant characteristics, the set of common applicant characteristics may include a frequency indicator representative of a higher frequency of occurrence among the set of applicants. The frequency indicator may be used to weight characteristics of the set of common applicant characteristics such that a match of a common applicant characteristic may have a greater effect on the determination of a level of interest of a member for a position with an organization.

In some instances, where the set of applicant data represents a set of applicants applying to the organization across a set of positions (e.g., a plurality of applicants applying for a plurality of differing positions), the profile module 230 generates a set of profiles. Each profile of the set of profiles may include a subset of applicant characteristics or a subset of common applicant characteristics for a specified position of the set of positions. In these embodiments, the subset of applicant characteristics is a subset of the set of applicant characteristics determined by the determination module 220.

In operation 340, the access module 210 accesses member data indicative of a member of the social network system 20. The member data including a set of member characteristics. The access module 210 can access the member data using the communication module 270 to transmit requests and responses between the access module 210 and one or more of the plurality of databases 28-32. In some embodiments, the member data is accessed by the access module 210 upon the member interacting with the social network system 20. For example, the member may generate an interrupt by entering search terms into a data entry field presented by the social network system 20 or an application (e.g., web browser) in communication with the social network system 20. The member data may also be accessed upon the member logging into the social network system 20 (e.g., through a website). Where the member is logged in, the social network system 20 may access the member data and provide updates to the member data based on interactions of the member on the social network system 20.

In some embodiments, a third party (e.g., a recruiter, a human resources professional, a hiring manager) attempting to determine an affinity between the member and the organization may cause the access module 210 to access the member data, or a publicly available portion thereof, by entering information indicative of the member into the social network system 20. For example, the access module 210 may access at least a portion of the member data based on the third party entering an identification for the member into a data entry field, such as a data entry field presented by a website in communication with the social network system 20. The identification for the member can be understood as any portion of data capable of uniquely identifying the member within the social network system 20. For example, the identification may be a name of the member, user name associated with the member on the social network system 20, or any other suitable identification information.

In operation 350, the score module 240 generates an interest score for the member based on a comparison of the member data and the applicant data. In some embodiments, the interest score can be understood as a quantification of the comparison of the member data and the applicant data to determine a level of interest or affinity between the member and the organization. Further, in some embodiments, the interest score can be understood as an estimation of how likely the member is to apply to the organization.

In some embodiments, in order to generate an interest score, member data may be mapped into standardized quantities. The standardized quantities may be understood as finite identification numbers, distinctly identifying information within a field of the member data. For example, the member data may include a title, an industry, a seniority level, and a geographical location. The title of Vice President may be reduced to VP or a numerical value of 38. The industry of software may be quantified into the value 144. The seniority may be quantified as 5. The geographical location may be reduced to US or 1. The organization data may also include an industry and a geographical location. The organization may span industries and include quantifications of the industry including multiple values, such as 144, 5, and 6. The geographical location can reduced to US or 1.

In some embodiments, using the standardized quantities discussed above, the interest score may be generated using a modified sigmoid function or a logit function. An example embodiment of a sigmoid function is shown below.

$$f ( {w}_{1} {x}_{1} + {w}_{2} {x}_{2} ) = \frac{1}{1 + {e}^{- ( {w}_{1} {x}_{1} + {w}_{2} {x}_{2} + B )}}$$

“X” may be understood to be one or more standardized values of one or more feature (e.g., skills, list of abilities, organization location, etc.); “w” may be understood to be a weight of the feature and may be determined through machine learning using the model module 260, discussed in further detail below; and B may be understood to be a constant learned from an interest model generated by the model module 260. In this embodiment, the equation may indicate a number in a range from 0 to 1, where 1 may indicate a match between the organization and the member and 0 may indicate no match.

Using the equation above, the interest score can be calculated from a comparison among the member data and the set of applicant characteristics including interests where all or a portion of the member data and the set of applicant characteristics are quantified and passed to the equation as input. In addition to the characteristics described above, the member data and applicant characteristics can include headline data (e.g., data included in a headline of a member profile and a headline of the applicant profiles from which the applicant data is extracted), a current position summary, a field of study string (e.g., a string of characters in the member profile or the applicant profile and applicant data indicating a field of study), a field of study tag, past organization data (e.g., headlines, summaries, or tags indicating organizations with which the member or applicant has been previously associated), and other factors, attributes, characteristics or the like among the member data and the applicant data and applicant characteristics.

In operation 360, the presentation module 250 causes presentation of an identification of the organization based on the interest score. The identification of the organization can be understood to be any identifying information about the organization. For example, the identification of the organization can take the form of a job listing, an organization profile, a link to job listing, a link to an organization profile, a website for the organization or a link to the website, or any other identifying information. The presentation module 250 may cause presentation of the identification by displaying the identification on a display device of the client device 34, transmitting the identification to the client device 34, or any other suitable method.

In some embodiments, where the method 300 is used to generate interest scores for the member for a plurality of organizations, the presentation module 250 can cause presentation of a plurality of identifications. In some embodiments, a set of identifications can be chosen for presentation where the set of identifications, selected from the plurality of identifications, are associated with interest scores exceeding a predetermined threshold. In this way, the member may be presented with the set of identifications for organizations with a relative high interest score, representing organizations in which the member is likely to be interested.

In some embodiments, the presentation module 250 may function in cooperation with the social network system 20 to produce a set of reoriented results. For example, the member can enter search terms within the social network system 20 (e.g., through a web browser displaying a web page associated with the social network system 20). One or more modules of the social network system 20 may generate a list of results (e.g., a set of organization identifications) in a first order (e.g., ranked by relevance to search terms entered by the user). Upon generation of the list of results, the method 300 may be initiated and produce an interest score for each organization identified by the list of results. The presentation module 250 may reorganize the list of results into a second order or rank (e.g., based on the interest scores of each organization), and cause presentation of the list of results to the member using the second order. In some embodiments, the second order may be based on a combination of factors, such as the interest scores of each organization, a relevance determination with respect to the search terms entered by the member, a location determination, and any other suitable factors influencing a list of results.

In some embodiments, where the method 300 is initiated after a set of results have been generated from a set of search terms, the method 300 may calculate interest scores only for organizations within the set of results which have been identified as having one or more open position (e.g., represented by job listings on the social network system 20). The presentation module 250, receiving the interest scores, may cause presentation of only the organizations for which interest scores have been generated. In some instances, the organizations for which interest scores have been generated may be prioritized and presented as a first set of results, with the remaining organizations being presented as a second set of results. In these instances, the first set of results (e.g., organizations with interest scores) may be presented in a manner distinct from the second set of results (e.g., an offset window), in a top portion of the list, or any other suitable manner to distinguish the first set of results from the second set of results.

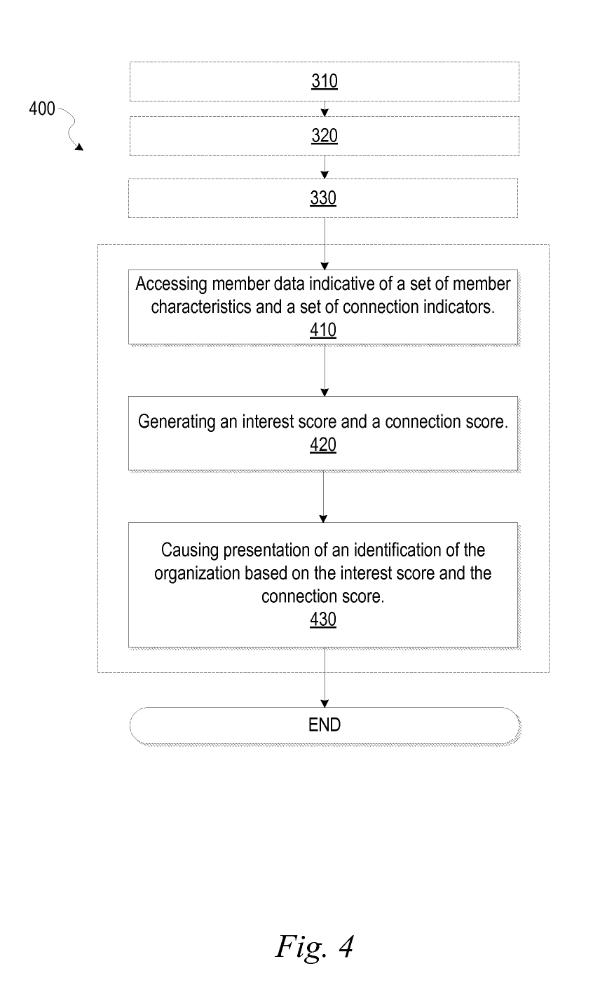

FIG. 4 is a flowchart illustrating an example method 400, consistent with various embodiments described herein. The method 400 may be performed at least in part by, for example, the organization interest system 26 illustrated in FIG. 2 (or application servers). In some embodiments, the method 400 includes one or more operations from the method 300, as shown in FIG. 4 and described below.

The method 400 may be performed by executing operations 310-330, described above. After operation 330, in operation 410, the access module 210 accesses member data indicative of a member of the social network system 20. The member data including a set of member characteristics and a set of connection indicators. The set of connection indicators can be understood as a portion of data representing a connection or association between two members of the social network system 20. In some embodiments, the set of connection indicators can represent direct connections or associations as well as indirect connections or associations. In some instances, the access module 210 accesses the set of member characteristics (e.g., included within the member profile) by accessing the database 28 and accesses the set of connection indicators (e.g., social network graph data) by accessing the database 30.

The set of connection indicators may represent an association between the member, whose member data has been accessed, and a first set of members of the social network system 20. The first set of members may include one or more applicants of the set of applicants. In these embodiments, a first subset of connection indicators represents an association among the member and the one or more applicants. In some embodiments, the connection indicators can extend beyond social connections to include Inmails (e.g., electronic communications) sent by the member to other members of the social network system 20 or to applicants or employees of the organization. Connection indicators can also include searches performed on organizations and on employees or applicants of the organizations; “likes” or other indications of approval of the organization, applicants or employees; comments posted by the member to the social network system 20, where the comments are applicable to or associated with the organization, applicant, or employee; selecting a post of the organization, applicant, or employee; and other actions performed by the member within the social network system 20. The first set of members can also include one or more employees of the organization. A second subset of connection indicators may represent an association among the member and the one or more employees of the organization.

The member data may also include a set of indirect connection indicators representing a secondary, tertiary, or other subsequent association with the organization. In these embodiments, the set of indirect connection indicators can represent a set of potential connections composed of first members of the social network system 20 which have an association with a second member of the social network system 20 connected to the member for whom the interest model is being generated. In some embodiments, the first members have not yet been identified as having a direct association with the member for whom the interest model is being generated. In some embodiments, the set of potential connections may be understood to include people who the member may know.

In operation 420, the score module 240 generates an interest score and a connection score. The interest score may be generated for the member based on a comparison of the member data, the applicant data, and the organization data. The connection score may be generated for the member based on the set of connection indicators and the applicant data. In some embodiments, the interest score may be generated similarly to the interest score generated in operation 350.

The connection score, generated based on the set of connection indicators and the applicant data may be understood to represent a connection strength between the member and the organization based on connections between the member and applicants or employees of the organization. The connection score can quantify a combination of aspects of the set of connection indicators. For example, the connection score can quantify connection strength based on a number of connections between the member and the set of applicants or employees of the organization. Further, the connection score may quantify connection strength based on a connection proximity between the member and applicants or employees of the organization. For example, the connection proximity can be a quantification of the direct or indirect nature of the connections between the member and the organization. The connection proximity may be determined to be higher where the member has a greater number of direct connections to employees of the organization than indirect connections. The connection score can be generated based on statistical classification modeling and machine learning functions such as regularization. Once the connection score have been generated, the scoring module 240 may integrate the connection score into the interest score such that the interest score includes input from the member data, the applicant data, and the set of connection indicators.

In operation 430, the presentation module 250 causes presentation of an identification of the organization based on the interest score and the connection score. In some embodiments, operation 430 can be performed similarly or the same as operation 360.

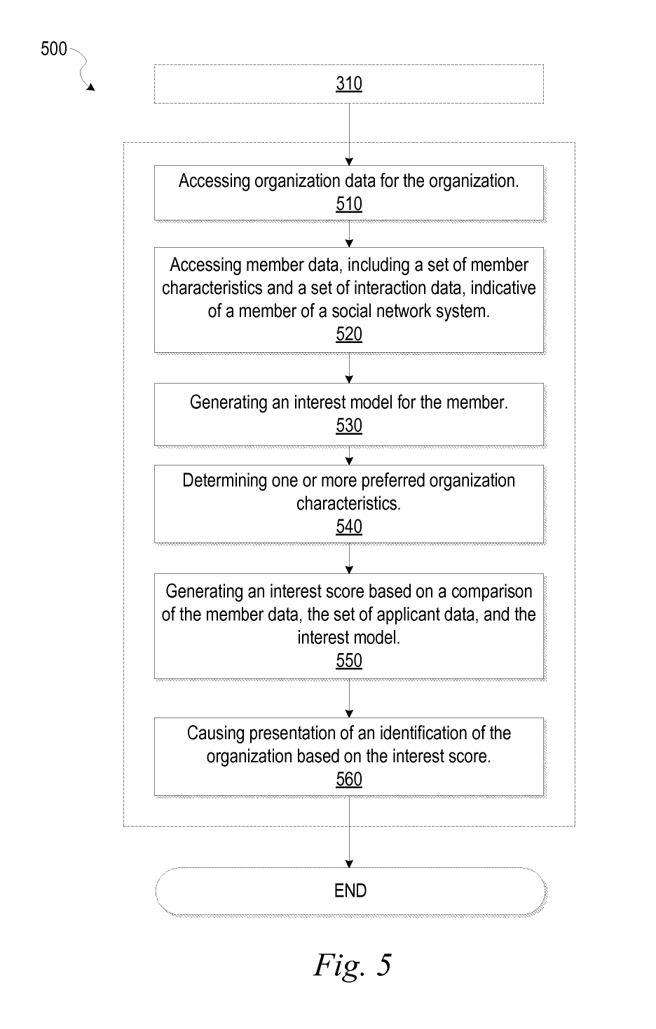

FIG. 5 is a flowchart illustrating an example method 500, consistent with various embodiments described herein. The method 500 may be performed at least in part by, for example, the organization interest system 26 illustrated in FIG. 2 (or application servers). In some embodiments, the method 500 includes one or more operations from the method 300, as shown in FIG. 5 and described below.

The method 500 may be initiated by performing operation 310. After accessing the set of applicant data, in operation 510, the access module 210 accesses organization data for the organization. The organization data including one or more organization characteristics. In some embodiments, the organization data can be in the form of an organization profile on the social network system 20, public records listings, a website associated with the organization, or any other information accessible by the access module 210. The access module 210 may access the organization data via the communication module 270 by transmitting requests and receiving responses over the network 36. Where the organization data is contained in an organization profile on the social network system 20, the access module 210 may access one or more of the databases 28-32 to retrieve the organization data.

In operation 520, the access module 210 accesses member data indicative of a member of the social network system 20. The member data including a set of member characteristics and a set of interaction data. The interaction data indicative of actions or interactions of the member with the social network system 20. The operation 520 can be performed similarly to the operation 410 or operation 340. For example, in some instances, the access module 210 can access the database 28 to retrieve the member data (e.g., member profile data) and access database 32 to retrieve the interaction data (e.g., a history of actions and behaviors in which the member engaged on the social network system 20).

The set of interaction data can include actions the member has taken with respect to interacting with various organization profiles, job searches, other member profiles, current employment, selection of links (e.g., reading articles linked within the social network system 20), applications for employment, organization searches, indications of interest (e.g., selecting a “like” or “favorite” option on a website in connection to an article, action, profile, or the like), or any other action or interaction which may provide indication as to a preference of the member.

For example, where the member has performed multiple searches for job listings, with each search geographically located within a thirty mile radius of the member's location, these actions can indicate a preference for a job local to the member. Further, where the member has elected to follow and search for jobs with organizations having a total employee number of less than one-hundred, these actions can indicate a preference for work with a small or mid-sized organization. As such, actions of the member may provide indications of any number of preferences relating to a field of study, a professional field, a set of organizations, a set of characteristics of an organization, a location preference, or any other set of preferences or preferred organization characteristics.

In some embodiments, in operation 530, the model module 260 generates an interest model for the member. The interest model can be understood to represent the member for use in generating interest scores. The interest model may be based on the set of member characteristics and the set of interactions. In the interest model, the set of interactions can indicate one or more member preference representative of one or more preferred organization characteristics. In some embodiments, using machine learning techniques, the interest model may include weighting factors associated with one or more of the set of preferences or one or more of the set of interactions. The weighting factors represent a relative effect of each preference of the set of preferences on determining whether the member will apply to an organization.

In some embodiments, the model module 260 incorporates machine learning techniques to generate and optimize interest models. For example, in some embodiments in which the model module 260 includes regularization techniques, the model module 260 can generate an interest model for use by the score module 240. The interest model may be understood as an optimization template, using historical interactions of the member, for use by the score module 240 to generate interest scores. The interest model may be configured using previous interest scores and subsequent outcomes relating to the previous interest scores, as well as previous interactions, social connections, and the like from member data on the social network system 20. Using the previous interest scores and outcomes, the interest model may weight certain applicant characteristics, portions of member data, or inputs into for use by the score module 240 in order to increase an accuracy of the generated interest score. The interest model may be generated through a combination of historical data and testing in order to determine, given a set of applicant data, organizational data, and member data, which characteristics are most determinative in a member's decision on whether to apply to an organization.

In some embodiments, the weighting factors may be determined by the model module 260 based on interactions of the member over a period of time prior to generation of the interest, where the interactions of the member include one or more preferred organization characteristics and an application to an organization. For example, where the member performs repeated searches for start-up companies within the same specified geographical location, and applied to one or more of the identified start-up companies, the model module 260 may determine that location and a status of an organization as a start-up company are important to the member and the member is likely to apply to an organization meeting both of these preferences in the future. The model module 260 may apply a weighting factor to a geographical location preference and a company status preference to reflect the increased likelihood of an application. In some embodiments,

In some embodiments, the model module 260 may generate a set of interest models for the member. Each interest model in the set of interest models may be based on interactions over one or more periods of time, a set of interactions of the user, combinations thereof, and other aspects, qualities, and characteristics of the member and the member's interactions. Each model of the set of interest models may generate an interest score. The interest scores generated by the set of interest models may be different (e.g., some indicating interest and others indicating little or no interest). Where the interest scores conflict, the model module 260 may perform an interest model polling to record votes of the set of interest models. The polling can be understood, in some embodiments, as determining whether a majority of the set of interest models indicate interest or lack of interest. The interest score may be considered an aggregate of the set of interest models where the interest score is determined by the interest scores of the majority of interest models of the set of interest models.

In some instances, an interest model may be calculated using techniques including probabilistic statistical classification modeling and regularization. For example, the interest score may be calculated using logistic regression and L1 regularization using the following equation.

$${min}_{w} - {\sum }_{{y}_{m , o} ∈ Ω} ( {y}_{m , o} log \frac{1}{1 + {exp}^{- {w}^{T} {x}_{m , o}}} + ( 1 - {y}_{m , o} ) log ( 1 - \frac{1}{1 + {exp}^{- {w}^{T} {x}_{m , o}}} ) ) + α {‖ w ‖}_{1}$$

The equation may represent a loss function that equates an error indicating a likelihood of whether a member will apply to an organization. In some embodiments, the equation may attempt to minimize the error as a determination of interest. Minimization can be understood as being equivalent to maximizing likelihood in the above-disclosed equation. The minimization controls complexity to avoid overfitting to prevent generalizing to other organizations and members.

As shown in the equation above, “m” stands for the member and “o” for the organization. In some embodiments, “o” can represent the organization using data extracted or processed from the applicant data or the applicant profile and the set of applicant characteristics. “X” may indicate a feature, such as a skill, list of attributes, company location, or other suitable features which are taken as the input of the equation and for which a score may be generated. “W” can indicate a weight of the attribute or a set of weights of attributes and may be understood as an output of the equation. As shown in the equation above, “y” is a label of a pair of the member and organization and is used as input for the equation. In some embodiments, “y” can be understood to be an interest label for the pair of member and organization where the attribute, whose weight is to be determined, is reflected by the pair as being present in both the member and the organization data. In at least some instances, “y” can take a value of either 1 or 0, where 1 indicates an interest and 0 indicates a lack of interest. “W” (e.g., the weight) can be understood to be a relative importance of the attribute. “T” may be a transpose signal, where “w” and “x” are vectors, to generate a column vector of one of the vectors “w” and “x.” In some embodiments, “a” is a parameter used to tune and control overfitting.

In operation 540, the determination module 220 determines one or more preferred organization characteristics based on organizations to which the member has applied. In embodiments where the interest model is generated, the determination module 220 can determine the one or more preferred organization characteristics from the interest model. Where no interest model has been generated, the determination module 220 may determine the one or more preferred organization characteristics from the set of interactions of the member. In either event, in order to determine the one or more preferred organization characteristics, the determination module 220 may initially accessing the set of interactions on one or more of the databases 28-32. In some embodiments, the determination module 220 may extract one or more common interactions from the set of interactions, where the common interactions represent interactions of the member which have been repeated over the period of time.

In operation 550, the score module 240 generates an interest score for the member based on a comparison of the member data and the set of applicant data. In some embodiments the score module 240 may generate the interest score based on the interest model, the member data, and the set of applicant data. In some embodiments, operation 550 may be performed similarly operation 350, described above.

In operation 560, the presentation module 250 causes presentation of an identification of the organization based on the interest score. In some embodiments, operation 560 can be performed similarly to operation 360 or operation 430.

### Example Mobile Device

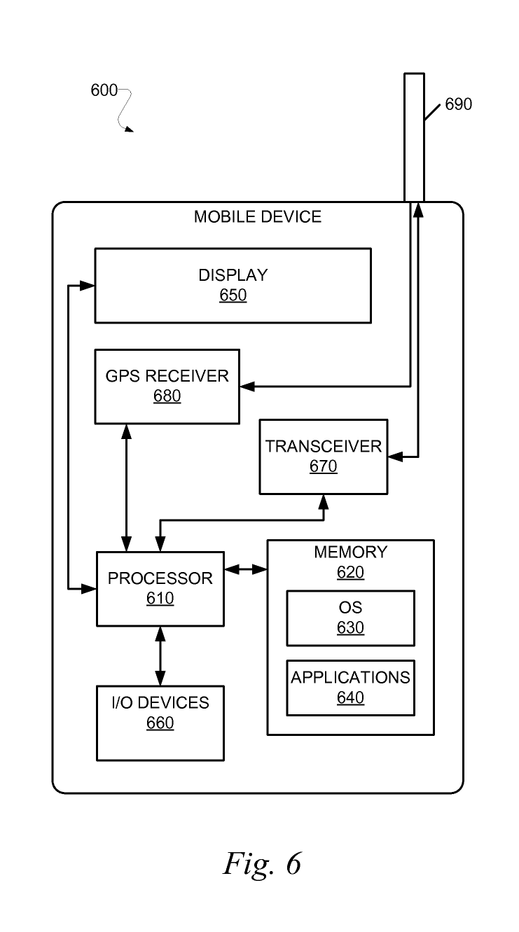

FIG. 6 is a block diagram illustrating the mobile device 600, according to an example embodiment. The mobile device may correspond to, for example, one or more client machines or application servers. In some embodiments, the mobile device 600 can include at least a portion of the organizational interest system 26. In some instances, the mobile device 600 can communicate with the application server modules 24 and at least a portion of the organizational interest system 26, stored on a separate machine or computing system, to enable a user of the mobile device 600 to interact with the organizational interest system 26. For example, the mobile device 600 can act as an input for user or member entered data (e.g., member data entered into the social network system 20, search queries, or input used by the method 300, the method 400, or the method 500) and an output for causing presentation of user interface elements by the presentation module 250. In some instances, one or more of the modules of the organizational interest system 26 illustrated in FIG. 2 may be implemented on or executed by the mobile device 600.

The mobile device 600 may include a processor 610. The processor 610 may be any of a variety of different types of commercially available processors suitable for mobile devices (for example, an XScale architecture microprocessor, a Microprocessor without Interlocked Pipeline Stages (MIPS) architecture processor, or another type of processor). A memory 620, such as a Random Access Memory (RAM), a Flash memory, or other type of memory, is typically accessible to the processor 610. The memory 620 may be adapted to store an operating system (OS) 630, as well as application programs 640, such as a mobile location enabled application that may provide location based services to a user. The processor 610 may be coupled, either directly or via appropriate intermediary hardware, to a display 650 and to one or more input/output (I/O) devices 660, such as a keypad, a touch panel sensor, a microphone, and the like. Similarly, in some embodiments, the processor 610 may be coupled to a transceiver 670 that interfaces with an antenna 690. The transceiver 670 may be configured to both transmit and receive cellular network signals, wireless data signals, or other types of signals via the antenna 690, depending on the nature of the mobile device 600. Further, in some configurations, a GPS receiver 680 may also make use of the antenna 690 to receive GPS signals.

### Modules, Components and Logic

Certain embodiments are described herein as including logic or a number of components, modules, or mechanisms. Modules (e.g., the access module 210, the determination module 220, the profile module 230, the score module 240, the presentation module 250, the model module 260, and the communication module 270) may constitute either software modules (e.g., code embodied (1) on a non-transitory machine-readable storage medium or (2) in a transmission signal and configuring hardware components of a machine or computer system) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable storage medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

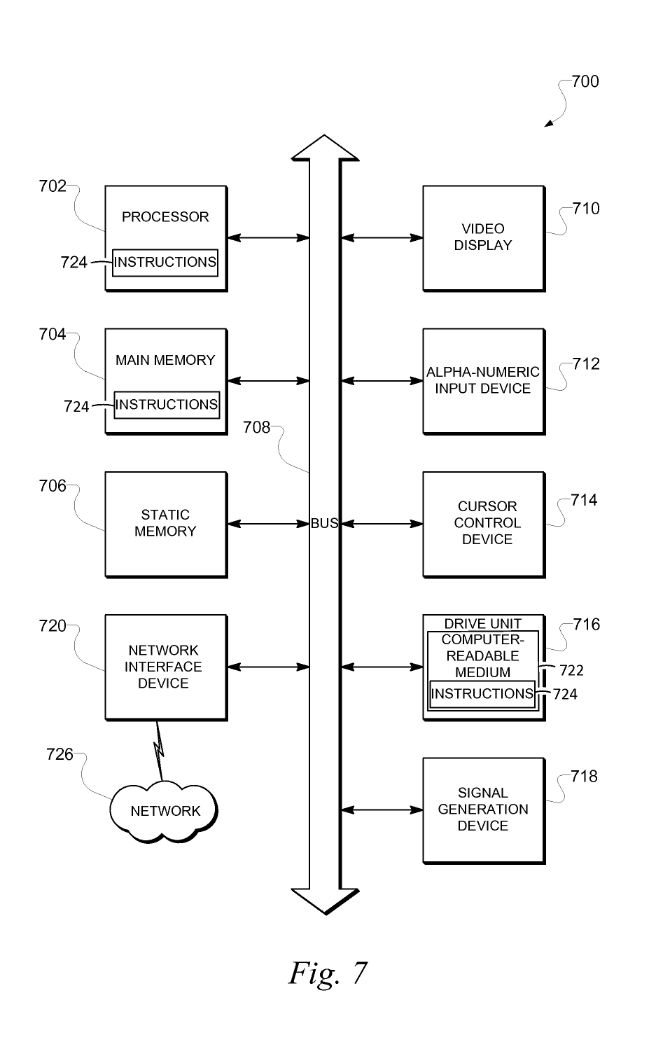

FIG. 7 is a block diagram of machine in the example form of a computer system 700 within which instructions, for causing the machine to perform any one or more of the methodologies discussed herein, may be executed. For example, the computer system 700 can form part or all of the social network system 20, store the profile data, social graph data, and member activity and behavior data of the data layer described in FIG. 1, and provide an interface through which the application server modules 24 and at least a portion of the organizational interest system 26 can be accessed. In some instances, the computer system can form all or a portion of the organizational interest system 26 and include the access module 210, the determination module 220, the profile module 230, the score module 240, the presentation module 250, the model module 260, and the communication module 270.

The machine can operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard or a touch-sensitive display screen), a user interface (UI) navigation device 714 (e.g., a mouse), a disk drive unit 716, a signal generation device 718 (e.g., a speaker) and a network interface device 720.

### Machine-Readable Storage Medium

The disk drive unit 716 includes a machine-readable storage medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable storage medium 722 is shown in an example embodiment to be a single storage medium, the term “machine-readable storage medium” may include a single storage medium or multiple media (e.g., a centralized or distributed database, and/or associated caches and servers) that store the one or more instructions or data structures. The term “machine-readable storage medium” shall also be taken to include any tangible storage medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable storage medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system, comprising:
one or more processors; and
a non-transitory machine-readable storage medium comprising processor executable instructions that, when executed by a processor of a machine, cause the machine to perform operations comprising:
receiving, by the one or more processors, a set of search terms from a client device;
generating, by the one or more processors, a set of search results including one or more organization identifications for one or more organizations;
in response to generating the set of search results, accessing a set of applicant data indicative of a set of applicants having applied to an organization of the one or more organizations, the set of applicant data including one or more applicant characteristics;
determining a set of common applicant characteristics from the applicant data among the set of applicant data, the set of common applicant characteristics including the applicant characteristics of the set of applicant data and a set of frequency indicators representing a frequency of occurrence of each applicant characteristic of the applicant characteristics;
accessing member data indicative of a member of an online social media network, the member data including a set of member characteristics, the member associated with the received set of search terms;
generating a plurality of interest models, each one of the interest models based on the member data and a set of interaction data for one or more period of times;
generating a set of interest scores for the member, each one of the interest scores based on a comparison of the member data, the set of common applicant characteristics, an interest model of the plurality of interest models, and the set of frequency indicators of the set of applicant data;
selecting an identification of the organization based on interest model polling of the interest scores generated from each interest model; and
causing presentation of the identification of the organization at the client device based on the interest score.

2. (canceled)

3. The system of claim 1, wherein the operations further comprise:
accessing organization data for the organization, the organization data including one or more organization characteristics.

4. The system of claim 3, wherein the member data includes one or more member preference representative of one or more preferred organization characteristics.

5. The system of claim 4, wherein the one or more preferred organization characteristics are determined based on organizations to which the member has applied.

6. The system of claim 4, wherein the interest model is based on the interest score and a comparison of the one or more preferred organization characteristics of the member and the one or more organization characteristics of the organization.

7. The system of claim 3, wherein the member data includes a set of connection indicators representative of an association between the member and a first set of members of the social media network.

8. The system of claim 7, wherein the first set of members includes one or more applicants of the set of applicants, wherein a first subset of connection indicators represent an association among the member and the one or more applicants, and wherein the model module is configured to generate the interest model based on the interest score and the first subset of connection indicators.

9. The system of claim 7, wherein the first set of members includes one or more employees of the organization, wherein a second subset of connection indicators represent an association among the member and the one or more employees of the organization, and wherein the model module is configured to generate the interest model based on the interest score and the second subset of connection indicators.

10. A method, comprising:
receiving, at one or more processors of a server, a set of search terms from a client device;
generating, by the one or more processors, a set of search results including one or more organization identifications for one or more organizations;
in response to generating the set of search results, accessing a set of applicant data indicative of a set of applicants having applied to an organization of the one or more organizations, the set of applicant data including one or more applicant characteristics;
determining a set of common applicant characteristics from the applicant data among the set of applicant data, the set of common applicant characteristics including the applicant characteristics of the set of applicant data and a set of frequency indicators representing a frequency of occurrence of each applicant characteristic of the applicant characteristics;
accessing member data indicative of a member of an online social media network, the member data including a set of member characteristics, the member associated with the received set of search terms;
generating a plurality of interest models, each one of the interest models based on the member data and a set of interaction data for one or more period of times;
generating a set of interest scores for the member, each one of the interest scores based on a comparison of the member data, the set of common applicant characteristics, an interest model of the plurality of interest models, and the set of frequency indicators of the set of applicant data;
selecting an identification of the organization based on interest model polling of the interest scores generated from each interest model; and
causing presentation of the identification of the organization at the client device based on the interest score.

11. (canceled)

12. The method of claim 10, further comprising:
accessing organization data for the organization, the organization data including one or more organization characteristics.

13. The method of claim 12, wherein the member data includes one or more member preference representative of one or more preferred organization characteristics.

14. The method of claim 13 further comprising:
determining the one or more preferred organization characteristics based on organizations to which the member has applied.

15. The method of claim 13, wherein the interest model is based on the interest score and a comparison of the one or more preferred organization characteristics of the member and the one or more organization characteristics of the organization.

16. The method of claim 12, wherein the member data includes a set of connection indicators representative of an association between the member and a first set of members of the social media network.

17. The method of claim 16, wherein the first set of members includes one or more applicants of the set of applicants, wherein a first subset of connection indicators represent an association among the member and the one or more applicants, and further comprising:
generating the interest model based on the interest score and the first subset of connection indicators.

18. The method of claim 16, wherein the first set of members includes one or more employees of the organization, wherein a second subset of connection indicators represent an association among the member and the one or more employees of the organization, and further comprising:
generating the interest model based on the interest score and the second subset of connection indicators.

19. A non-transitory machine-readable storage medium comprising processor executable instructions that, when executed by a processor of a machine, cause the machine to perform operations comprising:
receiving, at one or more processors of a server, a set of search terms from a client device;
generating, by the one or more processors, a set of search results including one or more organization identifications for one or more organizations;
in response to generating the set of search results, accessing a set of applicant data indicative of a set of applicants having applied to an organization of the one or more organizations, the set of applicant data including one or more applicant characteristics;
determining a set of common applicant characteristics from the applicant data among the set of applicant data, the set of common applicant characteristics including the applicant characteristics of the set of applicant data and a set of frequency indicators representing a frequency of occurrence of each applicant characteristic of the applicant characteristics;
accessing member data indicative of a member of an online social media network, the member data including a set of member characteristics, the member associated with the received set of search terms;
generating a set of interest models, each one of the interest models based on the member data and a set of interaction data for one or more period of times;
generating a set of interest scores for the member, each one of the interest scores based on a comparison of the member data, the set of common applicant characteristics, an interest model of the plurality of interest models, and the set of frequency indicators of the set of applicant data;
selecting an identification of the organization based on interest model polling of the interest scores generated from each interest model; and causing presentation of the identification of the organization at the client device based on the interest score.

20. (canceled)
